(19) United States
(12) Patent Application Publication
(10) Pub. No.: US 2008/0109714 A1
(43) Pub. Date: May 8, 2008

(54) Capturing screen information

(75) Inventors: Amar Kumar, Rauenberg (DE); Wolfgang E. Walter, Hambruecken (DE)

Correspondence Address: SAP/BLAKELY, 1279 OAKMEAD PARKWAY, SUNNYVALE, CA, 94085-4040, US

(73) Assignee: SAP AG

(21) Appl. No.: 11/592,786

(22) Filed: Nov. 3, 2006

(51) Int. Cl. G06F 3/048; G06F 17/00

(52) U.S. Cl. 715/234; 715/700; 715/762

(57) ABSTRACT

Computer user interface screen layouts may be converted into an Extensible Markup Language (“XML”) string, and recreated later (or elsewhere) by processing the XML string. Software to identify software components associated with user interface features, to create a static data structure describing the state of those software components, and to recreate the user interface features by reproducing the software component states is also described and claimed.

### FIELD

The invention relates to computer and data entry operations. More specifically, the invention relates to capturing user interface information to recreate a state of the user interface at a later time or different place.

### BACKGROUND

Database and data entry applications often have a large amount of information to present to a user. Presenting the information in an easy-to-understand arrangement that permits the user to add, query, modify and delete records efficiently, can contribute to improved productivity.

Some applications allow the user to customize the user interface so that frequently-used commands, controls and displays are placed in locations the user finds convenient, while seldom-used items and information that is not relevant or interesting to the user may be hidden to free screen area for other uses. Current systems may permit the user to save the positions of windows of a customized interface layout. However, additional refinements to user interface management may produce gains in convenience and productivity.

### BRIEF DESCRIPTION OF DRAWINGS

Embodiments of the invention are illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

FIG. 1 shows an overview of software and user interface state capture and recreation according to an embodiment of the invention.

FIG. 2 outlines a method of capturing software and user interface state according to an embodiment.

FIG. 3 shows how previously-captured state information can be used to recreate a user interface.

FIG. 4 shows some logical entities that may be present in an environment where an embodiment is used.

FIG. 5 shows how information and functionality may be divided among subsystems according to an embodiment.

FIG. 6 shows some components of a computer system that implements an embodiment of the invention.

### DETAILED DESCRIPTION

Embodiments of the invention convert a screen layout into a persistable (storable) form such as an Extensible Markup Language (“XML”) string representation. The stored layout or XML string can be used to recreate the original screen layout later, or on a different screen.

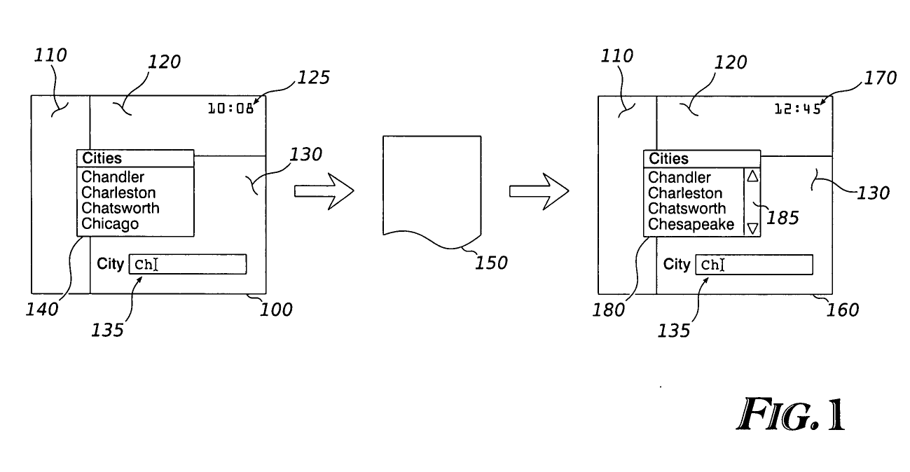

FIG. 1 shows a sample user interface screen 100 that contains a number of display elements. There are three tiled (non-overlapping) panes 110, 120 and 130, and a pop-up dialog window 140 that overlaps the tiled panes. A typical software application would present various sorts of text and graphics in the display panes, but most of that material has been omitted for clarity in FIG. 1. However, a current time 125 is shown in pane 120 and a text input field 135 is shown in pane 130. A partial city name “Ch” has been entered into text input field 135. Furthermore, dialog window 140 shows a list of city names that begin with “Ch.” This window might have been called up by a user operating the software application who wished to refer to a list of city names that could be entered into text input field 135.

According to an embodiment of the invention, screen layout 100 is transformed into an intermediate form 150, which can be saved for later use or transmitted to a different location. The intermediate form may be, for example, a static data structure or an Extensible Markup language (“XML”) string. Later (or elsewhere), a similar user interface 160 can be recreated by processing intermediate form 150. Certain aspects of recreated interface 160 are identical: tiled panes 110, 120 and 130 are the same sizes and in the same relative locations, and a pop-up dialog window 180 appears in the same location as dialog window 140. However, some elements are different. For example, clock 125 shows a different “current” time 170; that portion of the screen is not simply a verbatim copy of the source screen. Text input field 135 retains its contents (the partial city name “Ch”) but dialog window 180 displays a different list of city names. Here, a city named “Chesapeake” has been added to the list, and a “scroll bar” 185 appears because the list of cities is longer than can be displayed within the dialog window 180. Thus, although recreated interface 160 is mostly similar to the original screen layout 100, some details are different. Recreated interface 160 is not a simple pixel-by-pixel or character-by-character copy of the original.

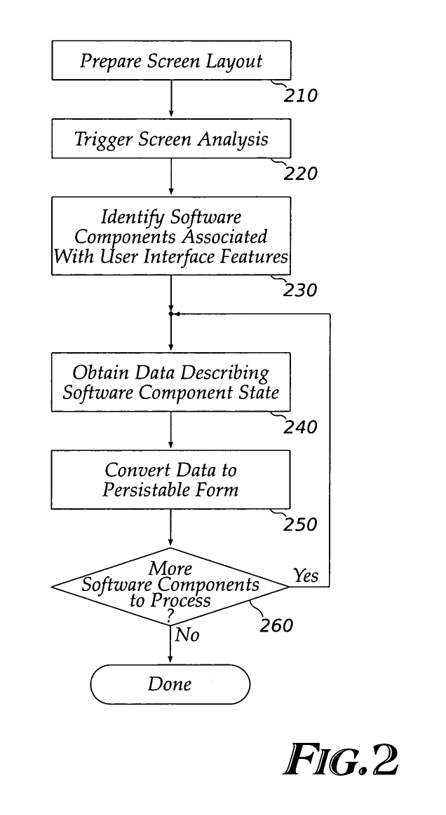

FIG. 2 outlines operations according to an embodiment of the invention. First, a screen layout is prepared (210). This may not entail any special activity on the user's part; he may simply interact with one or more software applications as he normally would, moving and resizing windows as necessary to adapt the screen layout to facilitate a task. Alternatively, in some embodiments, the application(s) may be operated in a “dry run” mode (not shown), where some ordinary operational features of the application(s) are unavailable, but the screen contents and window placements can be set as desired.

Once the desired screen layout is prepared, a screen analysis is triggered (220), for example, by pressing a predetermined key or selecting a menu option. The software components associated with presently-displayed user interface features are identified (230) and, for each component, data describing the software component's state are obtained (240) and converted to a persistable form (250). The data collected may include information such as the identity of the current user, the databases currently being accessed, the records being displayed, a history of recent user activity, and so on. Data describing any user interface features associated with the software component are also collected. For example, the position and size of tiled panes and/or overlapping windows, location of the mouse cursor, contents of any user-entry fields, and so on, may recorded.

If there are more software components to process (260), operations 240 and 250 are repeated. At the end of this process, data describing the internal state of one or more software functions or applications have been collected and converted into a persistable form, which can be stored or sent elsewhere, and processed to recreate the user interface at another place or time. If the persisted screen layout is saved, it may be assigned a name for easier identification, and may be stored in such a way that other users can use the layout themselves.

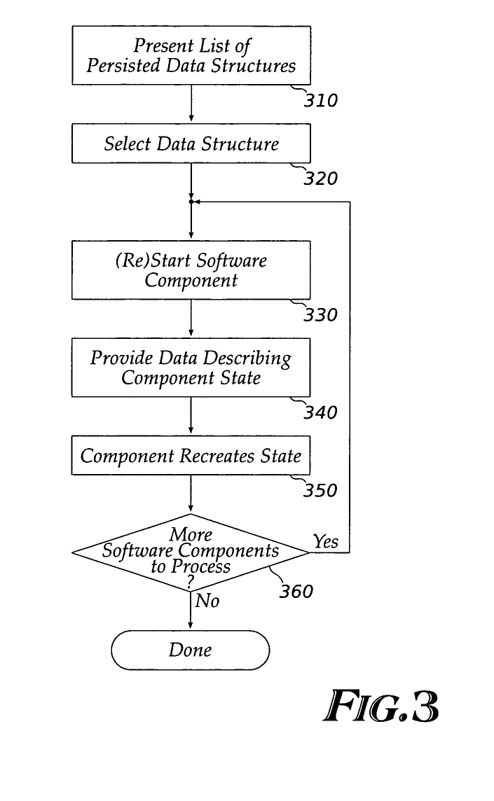

FIG. 3 shows one way of using persisted data like that created by the method described with respect to FIG. 2. In this example sequence, several different data structures are available. Each data structure may describe a different user interface arrangement and corresponding set of software components. A list of persisted data structures is presented (310), and the user selects one of the data structures (320). The selected structure is processed: a software component is started (or restarted or reconfigured, as appropriate) (330), and a portion of the selected data structure that described the software component's state when the data structure was saved is provided to the software component (340). The component uses the data to configure itself and recreate its earlier state (350). For example, previously-opened databases may be reopened, and records that were being inspected may be retrieved and redisplayed. Lower-level user interface features may also be restored: the mouse cursor may be moved to its previous location, text fields may be filled in, and command histories pre-configured.

If there are more software components to process (360), the embodiment loops back to repeat operations 330, 340 and 350. Once all the software components described in the selected data structure have been (re)started and configured, the previously-stored user interface state is recreated.

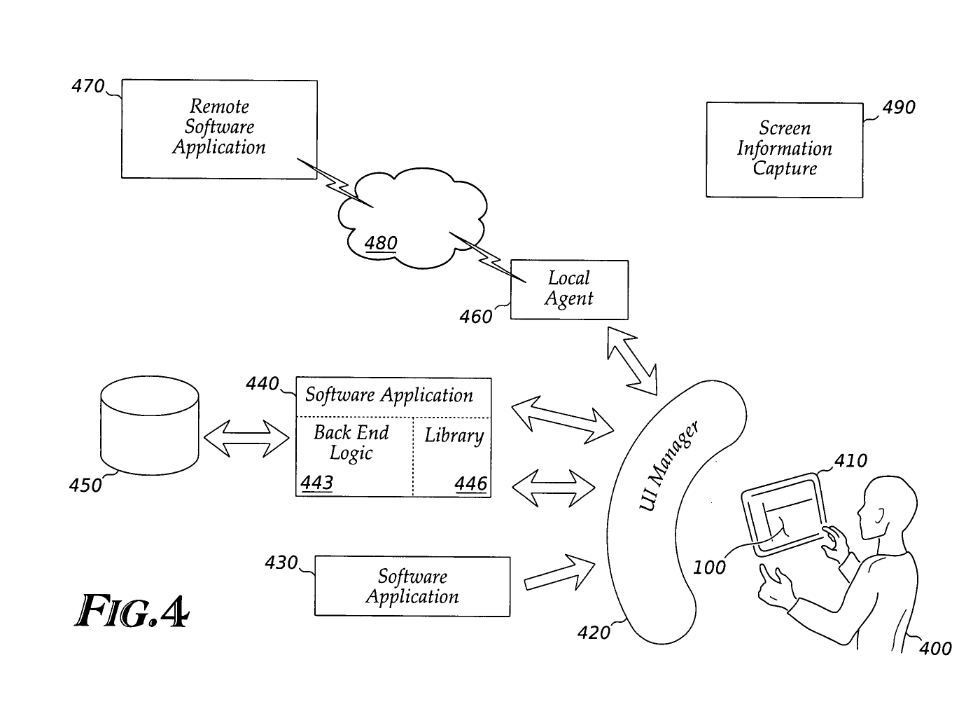

The software components discussed in relation to FIGS. 2 and 3 can have many different logical arrangements. FIG. 4 details some of the relationships that may be found in an environment where an embodiment of the invention is applied. The relationships may not be apparent to a user of the system, but may affect operations of an embodiment as discussed here.

A user 400 interacts with a computer system by viewing a user interface 100 displayed on a monitor 410. The components of the user interface—windows, graphics, text, data entry fields, and so on—may be drawn and maintained by a user interface (“UI”) manager 420. Software applications 430 and 440 interact with the user through the UI manager 420. For example, application 430 may send text to be drawn on monitor 410, and UI manager 420 can position the text correctly and draw those portions of the text that are not offscreen or obscured by, for example, an overlapping window.

An application such as software application 440 may separate calculation and display functions as shown: back-end logic 443 may interact with a database 450 to store or retrieve information, and may rely on a library 446 of functions that interact with the UI manager 420 to present information to user 400 and obtain new data from user 400.

In some environments, software applications may execute on a remote machine and interact with user 400 through a software stub that communicates with UI manager 420. FIG. 4 shows this arrangement: local agent 460 communicates with remote software application 470 over a distributed data network 480 such as the Internet. Information to be displayed to user 400, and data collected from user 400, pass through local agent 460.

The activities of an embodiment of the invention may be performed by a logical component identified in FIG. 4 as screen information capture 490. This may be a separate software thread, process, or application; or it may be integrated with another software entity. For example, in some embodiments, screen information capture 490 may be coupled with UI manager 420. In this arrangement, screen information capture logic 490 has ready access to information about the user interface 100 displayed on monitor 410. For example, the location of tiled and/or overlapping windows may be known, and the contents of any data input fields may be available. In addition, the software applications 430, 440 and 470 (the latter through local agent 460) can be contacted and queried.

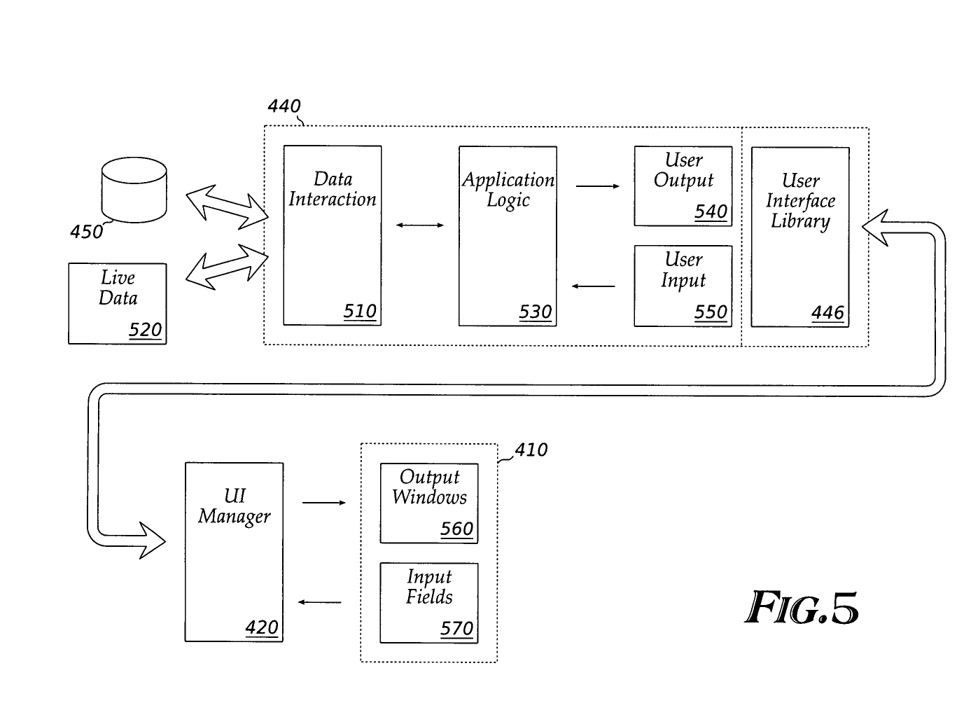

FIG. 5 shows a portion of the environment of FIG. 4 in greater detail. Software application 440 may include a number of logical subsystems: a data interaction subsystem 510 for retrieving data from, and/or sending data to, a database 450 or other mass storage device, or a live data source/sink 520. Application logic 530 operates on data from data interaction subsystem 510, produces information to be displayed to the user through user output subsystem 540, and coordinates application operations based on input from the user received through user input subsystem 550. User interface library 446 may provide functions to simplify the implementation of software application 440. The application interacts with UI manager 420, as described above in reference to FIG. 4. UI manager 420 performs final preparation of output windows 560, and manages basic user interaction with input fields 570, to implement the user interface displayed on monitor 410.

According to the division of functionality described with reference to FIGS. 4 and 5, UI manager 420 has little or no information about the meaning of any of the things it arranges to be displayed. On the other hand, a software application 440 may not have any use for detailed information about user actions such as pixel-by-pixel mouse movements and (some) keyboard activities. For the latter type of user-input information, software application 440 may instruct UI manager 420 to display certain features and to notify the application if the user performs certain actions. For example, software application 440 may cause a text input field to be displayed (see, e.g., element 135 of FIG. 1). However, software application 440 may be unequipped to manage each individual keystroke the user makes while entering data. Instead, UI manager 420 deals with text entry and editing, and software application 440 simply queries the contents of the field when the user indicates (for example, by pressing “Enter” or clicking on an “OK” button) that the entry is complete. Handling of other user entry features, such as menu bars, checkboxes and radio buttons, scroll bars and the like, may proceed similarly.

An embodiment of the invention interacts with various entities such as software applications and a user interface (“UI”) manager, as outlined in reference to FIGS. 2 and 3, and described in reference to FIGS. 4 and 5. Software applications and UI managers may implement a common interface for collecting and processing user interface state data. Such an interface can simplify the design and implementation of an embodiment of the invention, and also reduce the complexity of constructing (or retrofitting) a software application that can save and restore its internal state.

By collecting information from the UI manager (or from a similar software entity that deals with basic user interface actions), an embodiment can save and restore both partially-completed and fully-completed data entry states. For example, text entry fields can be recreated with their contents at the time the user interface was saved, and menus, buttons and other interface items can be placed in the same state. Also, user interface fields that maintain a history of previously-entered values can be restored with the same history.

When an embodiment of the invention collects information about software application and user interface state, it may place it in a “persistable” or “static” form. In other words, the information is formatted so that it may conveniently be stored (for example, in a file or a database) or transmitted over a communication channel of limited capability (for example, electronic mail). Many techniques for converting arbitrary binary data into easy-to-store, easy-to-transmit form are known in the art. For example, BASE-64 encoding transforms raw binary data into a longer stream of characters chosen from a limited alphabet. The Extensible Markup Language (“XML”) is another text-based representation that may be used with an embodiment of the invention. XML can represent hierarchical data within a serial character stream (“string”), can be machine processed relatively easily, and, in many cases, can be examined and edited by hand (albeit with greater difficulty).

An XML string can be combined with a second XML string or fragment to create a modified XML string containing different data. For example, an XML string representing a user interface state, prepared as described with reference to FIG. 2, can be combined with an XML fragment that adds or overrides certain information so that the screen layout produced when the combined XML string is processed is modified from the layout displayed when the original XML string was created. An XML fragment can re-position windows or display panes, change the contents of input fields, or place different data in input field history lists.

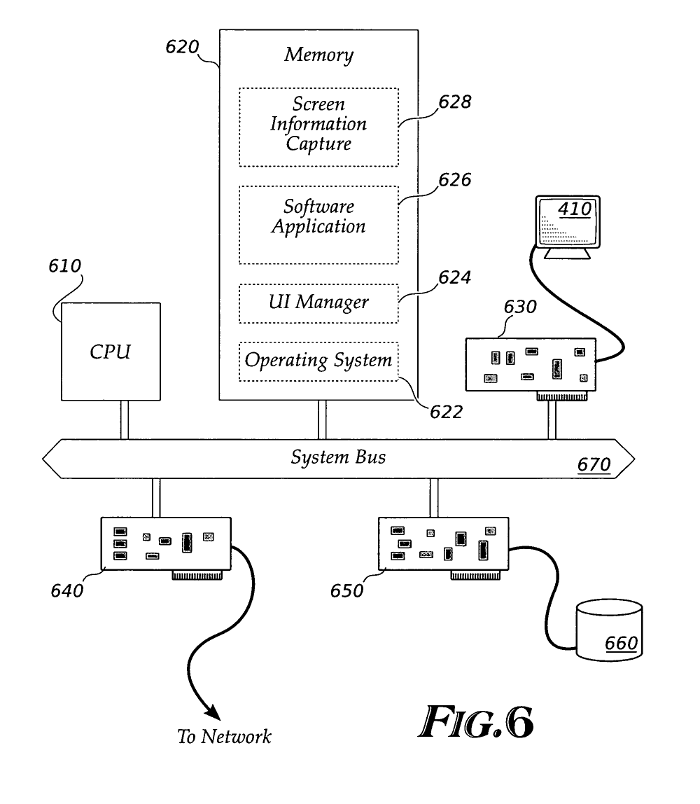

FIG. 6 shows some components of a computer system that implements an embodiment of the invention. Element 610 is a programmable processor (a central processing unit or “CPU”) that executes instructions stored in memory 620. Those instructions may include an operating system 622, a user interface (“UI”) manager 624, and a software application 626. Screen information capture logic 628, which implements an embodiment of the invention, may be separate, as shown, or may be integrated with another program. A system may contain hardware interfaces for communicating with external peripherals: video interface 630 for controlling monitor 410; network interface 640 for communicating via a network; and mass storage interface 650 for reading and writing data on a storage device such as hard disk 660. These system components are connected to, and communicate via, system bus 670.

An embodiment of the invention may be a machine-readable medium having stored thereon instructions which cause a programmable processor to perform operations as described above. In other embodiments, the operations might be performed by specific hardware components that contain hardwired logic. Those operations might alternatively be performed by any combination of programmed computer components and custom hardware components.

A machine-readable medium may include any mechanism for storing or transmitting information in a form readable by a machine (e.g., a computer), including but not limited to Compact Disc Read-Only Memory (CD-ROM), Read-Only Memory (ROM), Random Access Memory (RAM), and Erasable Programmable Read-Only Memory (EPROM).

The applications of the present invention have been described largely by reference to specific examples and in terms of particular allocations of functionality to certain hardware and/or software components. However, those of skill in the art will recognize that software and user interface states can also be captured, stored and recreated by software and hardware that distribute the functions of embodiments of this invention differently than herein described. Such variations and implementations are understood to be captured according to the following claims.

We claim:

1. A method comprising:
converting a screen layout into an Extensible Markup Language (“XML”) string; and
recreating the screen layout from the XML string at a different place or time.

2. The method of claim 1 wherein converting comprises:
identifying an internal state of a software function associated with a portion of the screen layout; and
incorporating the internal state into the XML string.

3. The method of claim 1, further comprising:
storing the XML string in a database.

4. The method of claim 1, further comprising:
initializing an input field of the recreated screen layout with a value from the XML string.

5. The method of claim 1, further comprising:
combining the XML string with an XML fragment to produce a modified XML string; and
processing the modified XML string to produce a modified screen layout.

6. The method of claim 1, further comprising:
transmitting the XML string to a remote system to recreate the screen layout on a remote display screen.

7. The method of claim 1 wherein converting comprises:
producing an XML representation describing a plurality of tiled panes.

8. The method of claim 1 wherein converting comprises:
producing an XML representation describing a plurality of partially-overlapping panes.

9. A computer-readable medium containing instructions to cause a programmable processor to perform operations comprising:
identifying software components associated with user interface features of a display screen;
creating a static data structure to describe states of the software components; and
processing the static data structure to recreate the user interface features of the display screen by reproducing the states of the software components.

10. The computer-readable medium of claim 9 wherein the static data structure is an Extensible Markup Language (“XML”) object.

11. The computer-readable medium of claim 9 wherein the states of the software components include contents of an input field of the display screen.

12. The computer-readable medium of claim 9 wherein the states of the software components include a history of entries of an input field of the display screen.

13. The computer-readable medium of claim 9, containing additional instructions to cause the programmable processor to perform operations comprising:
presenting a list of available static data structures;
accepting a selection of one of the available static data structures; and
processing the selected static data structure to recreate user interface features of a display screen corresponding to the selected static data structure.

14. A computer-readable medium containing instructions to cause a programmable processor to perform operations comprising:
collecting internal state information about a software application in response to a signal, the internal state information sufficient to reproduce a user interface display of the software application; and
converting the internal state information into a serialized data object.

15. The computer-readable medium of claim 14 wherein the serialized data object is a first serialized data object, the medium containing additional instructions to cause the programmable processor to perform operations comprising:
receiving a second serialized data object; and
replacing the user interface display of the software application with a restored user interface display corresponding to the second serialized data object.

16. The computer-readable medium of claim 14 wherein the serialized data object is an Extensible Markup Language (“XML”) string.

17. The computer-readable medium of claim 14, containing additional instructions to cause the programmable processor to perform operations comprising:
storing the serialized data object.

18. The computer-readable medium of claim 14 wherein the serialized data object contains information to populate an input field of the user interface display.

19. The computer-readable medium of claim 14 wherein the serialized data object contains information to cause a modal dialog to be displayed.
